(19) United States
(12) Patent Application Publication
(10) Pub. No.: US 2025/0222336 A1
(43) Pub. Date: Jul. 10, 2025

(54) PACE OF PLAY REPORTING FOR GOLF COURSES

(71) Applicant: Textron Inc., Providence, RI (US)

(72) Inventor: Christopher Alexander Boehm, North Augusta, SC (US)

(73) Assignee: Textron Inc., Providence, RI (US)

(21) Appl. No.: 18/406,566

(22) Filed: Jan. 8, 2024

(51) Int. Cl. A63B 71/06; A63B 57/00; A63B 69/36

(52) U.S. Cl. CPC A63B 71/0686; A63B 69/3691; A63B 57/505; A63B 2220/62; A63B 2220/805; A63B 2220/807; A63B 2220/808; A63B 2225/50

(57) ABSTRACT

A system includes a first sensor configured facilitate detecting a location of a golf cart, a second sensor configured to facilitate detecting tee shots taken at a tee box of a golf course, and a control system. The control system is configured to detect that the location of the golf cart is proximate a tee box area for the tee box, detect one or more tee shots at the tee box, record one or more tee shot timestamps associated with the one or more tee shots, detect when the golf cart leaves the tee box area, identify a respective tee shot timestamp of the one or more tee shot timestamps associated with a respective tee shot of the one or more tee shots immediately preceding the golf cart leaving the tee box area, and set the respective tee shot timestamp as a start of play for the golf cart.

### BACKGROUND

Pace of play is an important statistic for a golf course to accurately determine and monitor. Knowledge of pace of play helps identify groups of golfers that are playing slow and facilitate taking corrective actions, facilitate tee sheet optimization, etc. to make the golf course more efficient, more profitable, and, overall, more enjoyable for the golfers. However, determining when a respective golfer's round, as well as each hole, begins and ends can be inaccurate using current detection and monitoring strategies, which can thereby impact efficiency, profitability, and golfer enjoyment of the golf course.

### SUMMARY

One embodiment relates to a pace of play monitoring system for a golf course. The pace of play monitoring system includes a first sensor configured to be positioned on a golf cart and facilitate detecting a location thereof, a second sensor configured to facilitate detecting tee shots taken at a tee box of a hole of the golf course, and a control system. The control system is configured to detect that the location of the golf cart is proximate a tee box area for the tee box based on first data acquired with the first sensor, detect one or more tee shots at the tee box based on second data acquired with the second sensor, record one or more tee shot timestamps associated with the one or more tee shots, detect when the golf cart leaves the tee box area based on the first data, identify a respective tee shot timestamp of the one or more tee shot timestamps associated with a respective tee shot of the one or more tee shots immediately preceding the golf cart leaving the tee box area, and set the respective tee shot timestamp as a start of play for one or more occupants associated with the golf cart.

Another embodiment relates to a pace of play monitoring system for a golf course. The pace of play monitoring system includes one or more processing circuits. The one or more processing circuits are configured to receive data acquired with one or more sensors configured to facilitate detecting a presence of a golf cart within a tee box area of a hole of the golf course and facilitate detecting tee shots taken at a tee box of the tee box area, detect that the golf cart is within the tee box area based on the data, detect one or more tee shots at the tee box based on the data, record one or more tee shot timestamps associated with the one or more tee shots, detect when the golf cart leaves the tee box area based on the data, identify a respective tee shot timestamp of the one or more tee shot timestamps associated with a respective tee shot of the one or more tee shots immediately preceding the golf cart leaving the tee box area, and set the respective tee shot timestamp as a start of play for one or more occupants associated with the golf cart.

Still another embodiment relates to a pace of play monitoring system for a golf course. The pace of play monitoring system includes a golf cart and one or more processing circuits. The golf cart includes a microphone and a position sensor. The one or more processing circuits include at least one of (a) a first processing circuit positioned on the golf cart or (b) a second processing circuit positioned remote from the golf cart. The one or more processing circuits are configured to monitor a position of the golf cart based on position data acquired with the position sensor, activate the microphone in response to the golf cart being located within a tee box geofence associated with a tee box of the golf course, detect one or more tee shots at the tee box based on sound data acquired with the microphone, record one or more tee shot timestamps associated with the one or more tee shots, deactivate the microphone in response to the golf cart being located outside of the tee box geofence, identify a respective tee shot timestamp of the one or more tee shot timestamps associated with a respective tee shot of the one or more tee shots immediately preceding the golf cart leaving the tee box geofence, and set the respective tee shot timestamp as a start of play of a round of golf for one or more occupants associated with the golf cart.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

FIG. 1 is a perspective view of a vehicle, according to an exemplary embodiment.

FIG. 2 is a schematic block diagram of the vehicle of FIG. 1, according to an exemplary embodiment.

FIG. 3 is a is schematic block diagram of a site monitoring and control system including a plurality of the vehicles of FIG. 1, according to an exemplary embodiment.

FIG. 4 is a is schematic view of a golf course including a plurality of holes, according to an exemplary embodiment.

FIG. 5 is a detailed view of a tee box area for a respective hole of the golf course of FIG. 4 with a first group of golf carts within a tee box geofence associated with the tee box area, according to an exemplary embodiment.

FIG. 6 is a detailed view of the tee box area of FIG. 5 with a second group of golf carts within the tee box geofence, according to an exemplary embodiment.

FIG. 7 is a detailed view of the tee box area of FIG. 5 with a third group of golf carts within the tee box geofence, according to an exemplary embodiment.

FIG. 8 is a flow diagram of a method for determining a hole pace of play and a round pace of play for a golf cart, according to an exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

### Overall Vehicle

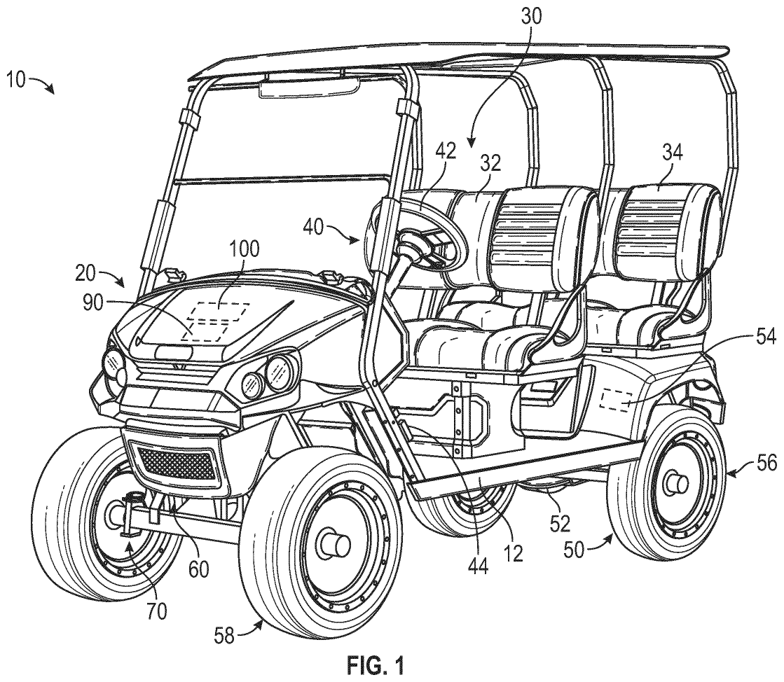

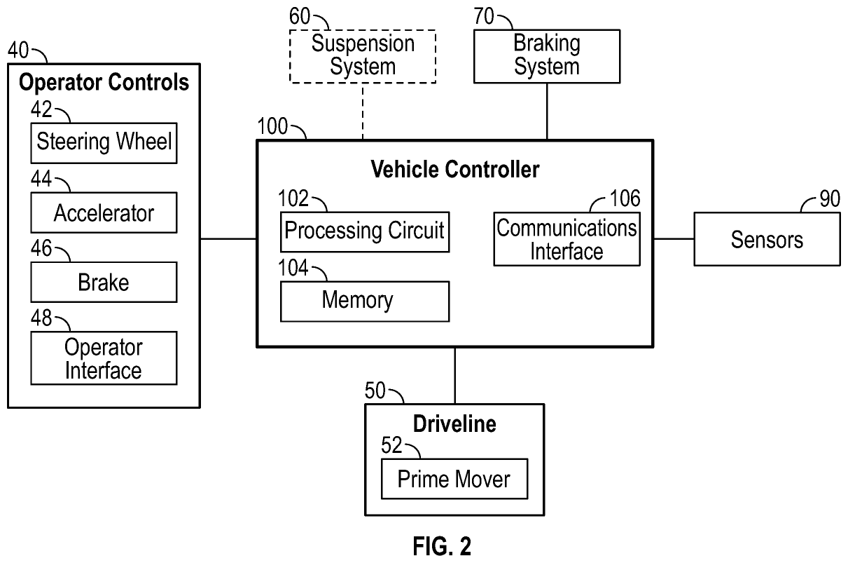

As shown in FIGS. 1 and 2, a machine or vehicle, shown as vehicle 10, includes a chassis, shown as frame 12; a body assembly, shown as body 20, coupled to the frame 12 and having an occupant portion or section, shown as occupant seating area 30; operator input and output devices, shown as operator controls 40, that are disposed within the occupant seating area 30; a drivetrain, shown as driveline 50, coupled to the frame 12 and at least partially disposed under the body 20; a vehicle suspension system, shown as suspension system 60, coupled to the frame 12 and one or more components of the driveline 50; a vehicle braking system, shown as braking system 70, coupled to one or more components of the driveline 50 to facilitate selectively braking the one or more components of the driveline 50; one or more first sensors, shown as sensors 90; and a vehicle control system, shown as vehicle controller 100, coupled to the operator controls 40, the driveline 50, the suspension system 60, the braking system 70, and the sensors 90. In some embodiments, the vehicle 10 includes more or fewer components.

According to an exemplary embodiment, the vehicle 10 is an off-road machine or vehicle. In some embodiments, the off-road machine or vehicle is a lightweight or recreational machine or vehicle such as a golf cart, an all-terrain vehicle (“ATV”), a utility task vehicle (“UTV”), and/or another type of lightweight or recreational machine or vehicle. In some embodiments, the off-road machine or vehicle is a chore product such as a lawnmower, a turf mower, a push mower, a ride-on mower, a stand-on mower, aerator, turf sprayers, bunker rake, and/or another type of chore product (e.g., that may be used on a golf course).

According to the exemplary embodiment shown in FIG. 1, the occupant seating area 30 includes a plurality of rows of seating including a first row of seating, shown as front row seating 32, and a second row of seating, shown as rear row seating 34. In some embodiments, the occupant seating area 30 includes a third row of seating or intermediate/middle row seating positioned between the front row seating 32 and the rear row seating 34. According to the exemplary embodiment shown in FIG. 1, the rear row seating 34 is facing forward. In some embodiments, the rear row seating 34 is facing rearward. In some embodiments, the occupant seating area 30 does not include the rear row seating 34. In some embodiments, in addition to or in place of the rear row seating 34, the vehicle 10 includes one or more rear accessories. Such rear accessories may include a golf bag rack, a bed, a cargo body (e.g., for a drink cart), and/or other rear accessories.

According to an exemplary embodiment, the operator controls 40 are configured to provide an operator with the ability to control one or more functions of and/or provide commands to the vehicle 10 and the components thereof (e.g., turn on, turn off, drive, turn, brake, engage various operating modes, raise/lower an implement, etc.). As shown in FIGS. 1 and 2, the operator controls 40 include a steering interface (e.g., a steering wheel, joystick(s), etc.), shown steering wheel 42, an accelerator interface (e.g., a pedal, a throttle, etc.), shown as accelerator 44, a braking interface (e.g., a pedal), shown as brake 46, and one or more additional interfaces, shown as operator interface 48. The operator interface 48 may include one or more displays and one or more input devices. The one or more displays may be or include a touchscreen, a LCD display, a LED display, a speedometer, gauges, warning lights, etc. The one or more input device may be or include buttons, switches, knobs, levers, dials, etc.

According to an exemplary embodiment, the driveline 50 is configured to propel the vehicle 10. As shown in FIGS. 1 and 2, the driveline 50 includes a primary driver, shown as prime mover 52, an energy storage device, shown as energy storage 54, a first tractive assembly (e.g., axles, wheels, tracks, differentials, etc.), shown as rear tractive assembly 56, and a second tractive assembly (e.g., axles, wheels, tracks, differentials, etc.), shown as front tractive assembly 58. In some embodiments, the driveline 50 is a conventional driveline whereby the prime mover 52 is an internal combustion engine and the energy storage 54 is a fuel tank. The internal combustion engine may be a spark-ignition internal combustion engine or a compression-ignition internal combustion engine that may use any suitable fuel type (e.g., diesel, ethanol, gasoline, natural gas, propane, etc.). In some embodiments, the driveline 50 is an electric driveline whereby the prime mover 52 is an electric motor and the energy storage 54 is a battery system. In some embodiments, the driveline 50 is a fuel cell electric driveline whereby the prime mover 52 is an electric motor and the energy storage 54 is a fuel cell (e.g., that stores hydrogen, that produces electricity from the hydrogen, etc.). In some embodiments, the driveline 50 is a hybrid driveline whereby (i) the prime mover 52 includes an internal combustion engine and an electric motor/generator and (ii) the energy storage 54 includes a fuel tank and/or a battery system. According to the exemplary embodiment shown in FIG. 1, the rear tractive assembly 56 includes rear tractive elements and the front tractive assembly 58 includes front tractive elements that are configured as wheels. In some embodiments, the rear tractive elements and/or the front tractive elements are configured as tracks.

According to an exemplary embodiment, the prime mover 52 is configured to provide power to drive the rear tractive assembly 56 and/or the front tractive assembly 58 (e.g., to provide front-wheel drive, rear-wheel drive, four-wheel drive, and/or all-wheel drive operations). In some embodiments, the driveline 50 includes a transmission device (e.g., a gearbox, a continuous variable transmission (“CVT”), etc.) positioned between (a) the prime mover 52 and (b) the rear tractive assembly 56 and/or the front tractive assembly 58. The rear tractive assembly 56 and/or the front tractive assembly 58 may include a drive shaft, a differential, and/or an axle. In some embodiments, the rear tractive assembly 56 and/or the front tractive assembly 58 include two axles or a tandem axle arrangement. In some embodiments, the rear tractive assembly 56 and/or the front tractive assembly 58 are steerable (e.g., using the steering wheel 42). In some embodiments, both the rear tractive assembly 56 and the front tractive assembly 58 are fixed and not steerable (e.g., employ skid steer operations).

In some embodiments, the driveline 50 includes a plurality of prime movers 52. By way of example, the driveline 50 may include a first prime mover 52 that drives the rear tractive assembly 56 and a second prime mover 52 that drives the front tractive assembly 58. By way of another example, the driveline 50 may include a first prime mover 52 that drives a first one of the front tractive elements, a second prime mover 52 that drives a second one of the front tractive elements, a third prime mover 52 that drives a first one of the rear tractive elements, and/or a fourth prime mover 52 that drives a second one of the rear tractive elements. By way of still another example, the driveline 50 may include a first prime mover 52 that drives the front tractive assembly 58, a second prime mover 52 that drives a first one of the rear tractive elements, and a third prime mover 52 that drives a second one of the rear tractive elements. By way of yet another example, the driveline 50 may include a first prime mover 52 that drives the rear tractive assembly 56, a second prime mover 52 that drives a first one of the front tractive elements, and a third prime mover 52 that drives a second one of the front tractive elements.

According to an exemplary embodiment, the suspension system 60 includes one or more suspension components (e.g., shocks, dampers, springs, etc.) positioned between the frame 12 and one or more components (e.g., tractive elements, axles, etc.) of the rear tractive assembly 56 and/or the front tractive assembly 58. In some embodiments, the vehicle 10 does not include the suspension system 60.

According to an exemplary embodiment, the braking system 70 includes one or more braking components (e.g., disc brakes, drum brakes, in-board brakes, axle brakes, etc.) positioned to facilitate selectively braking one or more components of the driveline 50. In some embodiments, the one or more braking components include (i) one or more front braking components positioned to facilitate braking one or more components of the front tractive assembly 58 (e.g., the front axle, the front tractive elements, etc.) and (ii) one or more rear braking components positioned to facilitate braking one or more components of the rear tractive assembly 56 (e.g., the rear axle, the rear tractive elements, etc.). In some embodiments, the one or more braking components include only the one or more front braking components. In some embodiments, the one or more braking components include only the one or more rear braking components. In some embodiments, the one or more front braking components include two front braking components, one positioned to facilitate braking each of the front tractive elements. In some embodiments, the one or more rear braking components include two rear braking components, one positioned to facilitate braking each of the rear tractive elements.

The sensors 90 may include various sensors positioned about the vehicle 10 to acquire vehicle information or vehicle data regarding operation of the vehicle 10 and/or the location thereof. By way of example, the sensors 90 may include an accelerometer, a gyroscope, a compass, a position sensor (e.g., a GPS sensor, etc.), suspension sensor(s), wheel sensors, an audio sensor or microphone, a camera, an optical sensor, a proximity detection sensor, and/or other sensors to facilitate acquiring vehicle information or vehicle data regarding operation of the vehicle 10 and/or the location thereof. According to an exemplary embodiment, one or more of the sensors 90 are configured to facilitate detecting and obtaining vehicle telemetry data including position of the vehicle 10, whether the vehicle 10 is moving, travel direction of the vehicle 10, slope of the vehicle 10, speed of the vehicle 10, vibrations experienced by the vehicle 10, sounds proximate the vehicle 10, suspension travel of components of the suspension system 60, and/or other vehicle telemetry data.

The vehicle controller 100 may be implemented as a general-purpose processor, an application specific integrated circuit (“ASIC”), one or more field programmable gate arrays (“FPGAs”), a digital-signal-processor (“DSP”), circuits containing one or more processing components, circuitry for supporting a microprocessor, a group of processing components, or other suitable electronic processing components. According to the exemplary embodiment shown in FIG. 2, the vehicle controller 100 includes a processing circuit 102, a memory 104, and a communications interface 106. The processing circuit 102 may include an ASIC, one or more FPGAs, a DSP, circuits containing one or more processing components, circuitry for supporting a microprocessor, a group of processing components, or other suitable electronic processing components. In some embodiments, the processing circuit 102 is configured to execute computer code stored in the memory 104 to facilitate the activities described herein. The memory 104 may be any volatile or non-volatile or non-transitory computer-readable storage medium capable of storing data or computer code relating to the activities described herein. According to an exemplary embodiment, the memory 104 includes computer code modules (e.g., executable code, object code, source code, script code, machine code, etc.) configured for execution by the processing circuit 102. In some embodiments, the vehicle controller 100 may represent a collection of processing devices. In such cases, the processing circuit 102 represents the collective processors of the devices, and the memory 104 represents the collective storage devices of the devices.

In one embodiment, the vehicle controller 100 is configured to selectively engage, selectively disengage, control, or otherwise communicate with components of the vehicle 10 (e.g., via the communications interface 106, a controller area network (“CAN”) bus, etc.). According to an exemplary embodiment, the vehicle controller 100 is coupled to (e.g., communicably coupled to) components of the operator controls 40 (e.g., the steering wheel 42, the accelerator 44, the brake 46, the operator interface 48, etc.), components of the driveline 50 (e.g., the prime mover 52), components of the braking system 70, and the sensors 90. By way of example, the vehicle controller 100 may send and receive signals (e.g., control signals, location signals, etc.) with the components of the operator controls 40, the components of the driveline 50, the components of the braking system 70, the sensors 90, and/or remote systems or devices (via the communications interface 106 as described in greater detail herein).

### Site Monitoring and Control System

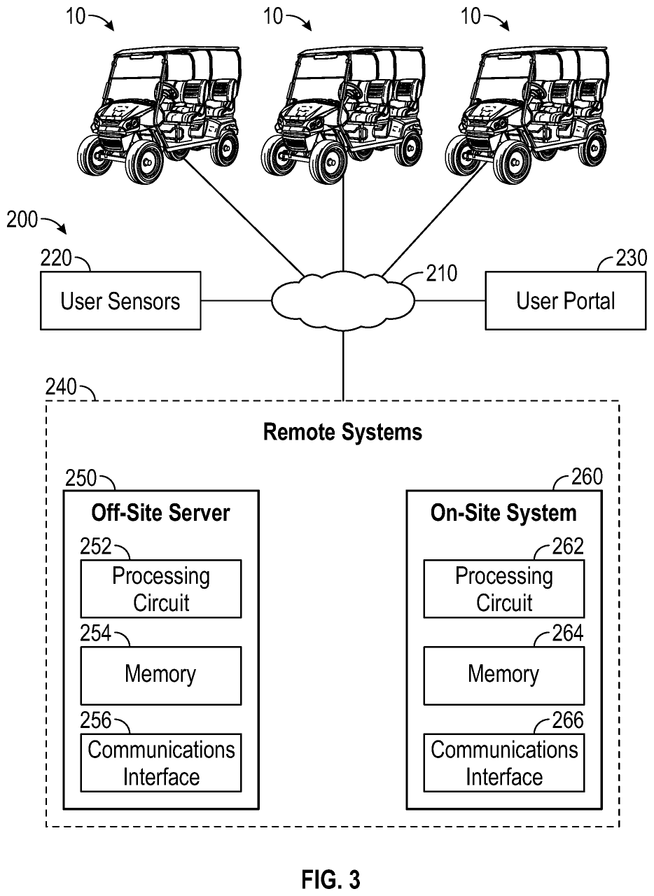

As shown in FIG. 3, a monitoring and control system, shown as site monitoring and control system 200, includes one or more vehicles 10; one or more second sensors, shown as user sensors 220, positioned remote or separate from the vehicles 10; an operator interface, shown as user portal 230, positioned remote or separate from the vehicles 10; and one or more external processing systems, shown as remote systems 240, positioned remote or separate from the vehicles 10. The vehicles 10, the user sensors 220, the user portal 230, and the remote systems 240 communicate via one or more communications protocols (e.g., Bluetooth, Wi-Fi, cellular, radio, through the Internet, etc.) through a network, shown as communications network 210.

The user sensors 220 may be or include one or more sensors that are carried by or worn by an operator of one of the vehicles 10. By way of example, the user sensors 220 may be or include a wearable sensor (e.g., a smartwatch, a fitness tracker, a pedometer, hear rate monitor, etc.) and/or a sensor that is otherwise carried by the operator (e.g., a smartphone, etc.) that facilitates acquiring and monitoring operator data (e.g., physiological conditions such a temperature, heartrate, breathing patterns, etc.; location; movement; etc.) regarding the operator. The user sensors 220 may communicate directly with the vehicles 10, directly with the remote systems 240, and/or indirectly with the remote systems 240 (e.g., through the vehicles 10 as an intermediary).

The user portal 230 may be configured to facilitate operator access to dashboards including the vehicle data, the operator data, information available at the remote systems 240, etc. to manage and operate the site (e.g., golf course) such as for advanced scheduling purposes, to identify persons braking course guidelines or rules, to monitor locations of the vehicles 10, etc. The user portal 230 may also be configured to facilitate operator implementation of configurations and/or parameters for the vehicles 10 and/or the site (e.g., setting speed limits, setting geofences, etc.). The user portal 230 may be or may be accessed via a computer, laptop, smartphone, tablet, or the like.

As shown in FIG. 3, the remote systems 240 include a first remote system, shown as off-site server 250, and a second remote system, shown as on-site system 260 (e.g., in a clubhouse of a golf course, on the golf course, etc.). In some embodiments, the remote systems 240 include only one of the off-site server 250 or the on-site system 260. As shown in FIG. 3, (a) the off-site server 250 includes a processing circuit 252, a memory 254, and a communications interface 256 and (b) the on-site system 260 includes a processing circuit 262, a memory 264, and a communications interface 266.

According to an exemplary embodiment, the remote systems 240 (e.g., the off-site server 250 and/or the on-site system 260) are configured to communicate with the vehicles 10 and/or the user sensors 220 via the communications network 210. By way of example, the remote systems 240 may receive the vehicle data from the vehicles 10 and/or the operator data from the user sensors 220. The remote systems 240 may be configured to perform back-end processing of the vehicle data and/or the operator data. The remote systems 240 may be configured to monitor various global positioning system (“GPS”) information and/or real-time kinematics (“RTK”) information (e.g., position/location, speed, direction of travel, geofence related information, etc.) regarding the vehicles 10 and/or the user sensors 220. The remote systems 240 may be configured to transmit information, data, commands, and/or instructions to the vehicles 10. By way of example, the remote systems 240 may be configured to transmit GPS data and/or RTK data based on the GPS information and/or RTK information to the vehicles 10 (e.g., which the vehicle controllers 100 may use to make control decisions). By way of another example, the remote systems 240 may send commands or instructions to the vehicles 10 to implement.

According to an exemplary embodiment, the remote systems 240 (e.g., the off-site server 250 and/or the on-site system 260) are configured to communicate with the user portal 230 via the communications network 210. By way of example, the user portal 230 may facilitate (a) accessing the remote systems 240 to access data regarding the vehicles 10 and/or the operators thereof and/or (b) configuring or setting operating parameters for the vehicles 10 (e.g., geofences, speed limits, times of use, permitted operators, etc.). Such operating parameters may be propagated to the vehicles 10 by the remote systems 240 (e.g., as updates to settings) and/or used for real time control of the vehicles 10 by the remote systems 240.

### Pace of Play Reporting

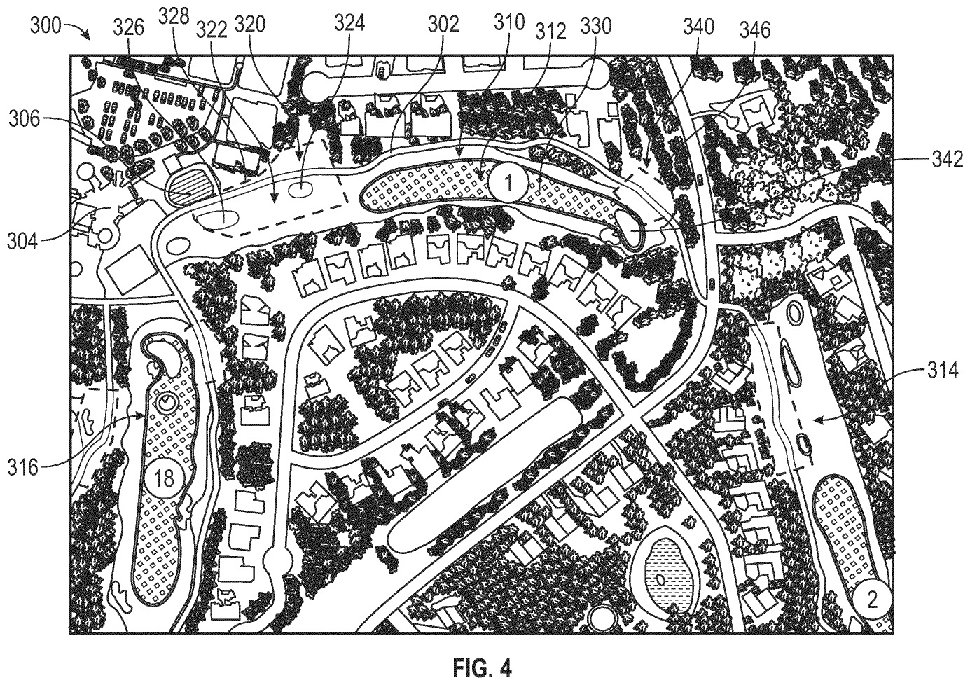

According to an exemplary embodiment, the site monitoring and control system 200, including the vehicle controller 100, the user sensors 220, the user portal 230, and the remote systems 240 (which may be referred to herein as a “pace of play monitoring and/or reporting system”), is configured to facilitate improving or enhancing the detection, monitoring/tracking, and reporting of pace of play of golf carts on a hole-by-hole basis and/or on a round-by-round basis. Generally, as described in greater detail herein, the improved or enhanced pace of play reporting is provided using the sensors 90 of the vehicle 10 including the microphone and the position sensor (or alternatively the user sensors 220 in the form of a smart phone or other device carried by an operator of the vehicle 10 with a built in microphone and/or position sensor). Further, it should be understood that any of the functions or processes described herein with respect to the site monitoring and control system 200 may be performed by the vehicle controller 100 and/or the remote systems 240. By way of example, data collection may be performed by the vehicle controller 100 and data analytics may be performed by the vehicle controller 100. By way of another example, data collection may be performed by the vehicle controller 100 and data analytics may be performed by the remote systems 240. By way of yet another example, data collection may be performed by the vehicle controller 100, a first portion of data analytics may be performed by the vehicle controller 100, and a second portion of data analytics may be performed by the remote systems 240. By way of still another example, a first portion of data collection may be performed by the vehicle controller 100, a second portion of data collection may be performed by the remote systems 240, and data analytics may be performed by the vehicle controller 100 and/or the remote systems 240. The improved pace of play detecting, monitoring/tracking, and reporting will be described herein in the context of FIGS. 4-7.

As shown in FIG. 4, a site, shown as golf course 300, includes a path, shown as cart path 302, a main building, shown as clubhouse 304, a training area (e.g., a short-game practice area, a driving range, practice putting green, etc.), shown as practice area 306, and a plurality of holes (e.g., nine holes, eighteen holes, etc.), show as holes 310, including a first hole 312, a second hole 314, and so on up to a final or last hole 316. The cart path 302 provides a path for the vehicles 10 to drive along between the holes 310 spaced across the golf course 300 over a round of golf.

As shown in FIG. 4, each of the holes 310 includes a first portion, shown as tee box area 320, a second portion, shown as fairway 330, and a third portion, shown as green area 340. As shown in FIGS. 4-7, the tee box area 320 includes a plurality of tee boxes, shown as tee boxes 322, including a first tee box, shown as tee box 324, and a second tee box, shown as tee box 326. In some embodiments, the tee box area 320 includes a different number of tee boxes 322 (e.g., one, three, four, etc.). As shown in FIG. 4, the tee box area 320 includes a first geofence, shown as tee box geofence 328, associated therewith. The tee box geofence 328 extends around (a) the tee boxes 322 of the respective hole 310 that the tee box geofence 328 is associated with, (b) a portion of the cart path 302 adjacent or proximate the tee boxes 322, and (c) in some cases, additional areas on which the vehicle 10 may park when arriving at the tee box area 320 of the respective hole 310 (e.g., a grass patch next to the cart path 302). The green area 340 includes a green 342 and a second geofence, shown as green geofence 346, associated therewith. The green geofence 346 extends around (a) a portion of the cart path 302 adjacent or proximate the green 342 and (b) additional areas on which the vehicle 10 may park when arriving at the green area 340 of the respective hole 310 (e.g., a grass patch next to the cart path 302).

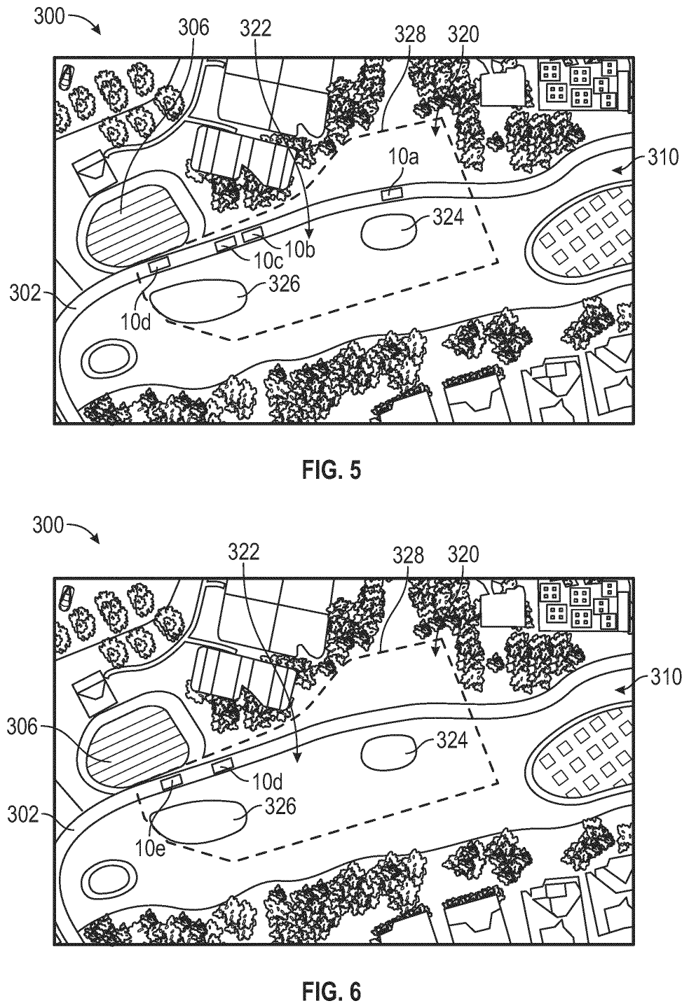

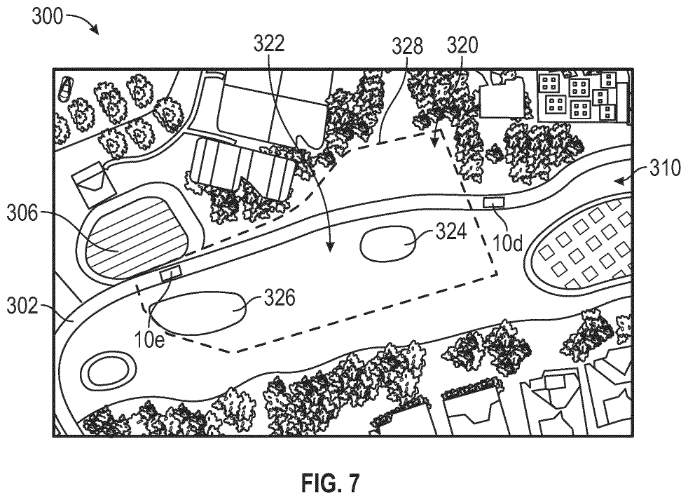

As shown in FIGS. 5-7, a plurality of the vehicles 10 including a first golf cart 10a, a second golf cart 10b, a third golf cart 10c, a fourth golf cart 10d, and a fifth golf cart 10e enter and leave the tee box geofence 328 for a respective hole 310 (e.g., the first hole 312) at different points in time. More specifically, as shown in FIG. 5, at a first point in time, (a) the first golf cart 10a is parked along the cart path 302 proximate the tee box 324 within the tee box geofence 328, (b) the second golf cart 10b and the third golf cart 10c are parked in line or queued behind the first golf cart 10a along the cart path 302 within the tee box geofence 328 waiting for access to the tee box 324, and (c) the fourth golf cart 10d just entered the tee box geofence 328 and is parked along the cart path 302 proximate the practice area 306. As shown in FIG. 6, at a second point in time after the first point in time, (a) the first golf cart 10a, the second golf cart 10b, and the third golf cart 10c have exited the tee box geofence 328 (e.g., after teeing off, to continue on with play, etc.), (b) the fourth golf cart 10d has moved up and parked along the cart path 302 proximate the tee box 326 within the tee box geofence 328, and (c) the fifth golf cart 10e has entered the tee box geofence 328 and is parked along the cart path 302 proximate the practice area 306 within the tee box geofence 328 behind the fourth golf cart 10d. As shown in FIG. 7, at a third point in time after the second point in time, the fourth golf cart 10d has just exited the tee box geofence 328 (e.g., following its occupants teeing off).

As shown in FIGS. 5-7, multiple golf carts can be positioned within the tee box geofence 328 for different reasons (e.g., to tee off, to get in line to tee off, to practice at the practice area 306, while they are in the clubhouse 304, etc.). Further, some golf carts may enter and leave the tee box geofence 328 at different times relative to its occupants teeing off. One strategy that can be implemented to determine when the occupants of a respective golf cart teed off and started play is to monitor for when the respective golf cart exits the tee box geofence 328. However, some players may not leave the tee box area 320 immediately after teeing off and, therefore, such a strategy can be inaccurate, which can make pace of play determined using such data unreliable. The site monitoring and control system 200 (e.g., the vehicle controller 100 and/or the remote systems 240) of the present disclosure mitigates such inaccuracies, which improves the pace of play data such that the pace of play data is more reliable and accurate.

The functions of the site monitoring and control system 200 will be described herein in relation to the fourth golf cart 10d of FIGS. 5-7. According to an exemplary embodiment, the site monitoring and control system 200 (e.g., the vehicle controller 100, the remote systems 240, etc.) is configured to monitor the location of the fourth golf cart 10d (e.g., based on data acquired from the position sensor of the sensors 90 of the fourth golf cart 10d) and detect or determine when the fourth golf cart 10d enters the tee box geofence 328 (e.g., at the first point of time of FIG. 5, for the first hole 312, for the initial hole of the round which may not be the first hole 312, etc.). When the fourth golf cart 10d enters the tee box geofence 328, the site monitoring and control system 200 is configured to activate or turn on the microphone of the sensors 90 of the fourth golf cart 10d. The site monitoring and control system 200 is then configured to acquire sound data from the microphone regarding sounds proximate the fourth golf cart 10d. More specifically, the site monitoring and control system 200 is configured to detect sounds that resemble tee shots and then record a tee shot timestamp associated with each tee shot detected until the fourth golf cart 10d exits the tee box geofence 328.

So, in reference to FIG. 5, the site monitoring and control system 200 is configured to record a tee shot timestamp for each tee shot detected for the occupants of the first golf cart 10a, the second golf cart 10b, and the third golf cart 10c. Then, in reference to FIG. 6, the site monitoring and control system 200 is configured to continue recording a tee shot timestamp for each tee shot detected for the occupants of the fourth golf cart 10d. Then, in reference to FIG. 7, the site monitoring and control system 200 is configured to continue monitoring the location of the fourth golf cart 10d and detect or determine when the fourth golf cart 10d exits the tee box geofence 328 (e.g., at the third point of time of FIG. 7). In response to detecting that the fourth golf cart 10d exited the tee box geofence 328, the site monitoring and control system 200 is configured to (a) deactivate or turn off the microphone of the sensors 90 of the fourth golf cart 10d and (b) identify a respective tee shot timestamp associated with the sound of a respective tee shot that occurred immediately preceding the fourth golf cart 10d exiting the tee box geofence 328. Then, the site monitoring and control system 200 is configured to set or record the respective tee shot timestamp as the start of play for the round and the respective hole 310 (e.g., the first hole 312) for the occupants of the fourth golf cart 10d.

In some embodiments, the site monitoring and control system 200 (e.g., the memory 104 of the vehicle controller 100, the memory 254, 264 of the remote systems 240, etc.) is configured to store or access a library of sound profiles associated with a plurality of different types of clubs (e.g., drivers, woods, wedges, hybrids, etc.) and/or a plurality of different types of brands (e.g., TaylorMade, Callaway, Ping, Titleist, etc.). In such embodiments, the site monitoring and control system 200 may be configured to compare one or more characteristics of the sounds captured by the microphone (e.g., frequency, amplitude, decibels, pitch, etc.) to the library of sound profiles to detect the tee shots. In some embodiments, the site monitoring and control system 200 is otherwise configured to detect the tee shots (e.g., a distinct sound other than ambient noise, a sound with a decibel level or amplitude over a certain sound threshold, etc.).

The site monitoring and control system 200 may also be configured to continue monitoring the location of the fourth golf cart 10d to facilitate detecting or determining when the fourth golf cart 10d enters and subsequently exits the green geofence 346 for the respective hole 310. The site monitoring and control system 200 may then be configured to (a) record a green exit timestamp for the respective hole 310 and (b) determine a pace of play for the respective hole 310 based on the difference between the tee shot timestamp and the green exit timestamp associated with the respective hole 310.

The site monitoring and control system 200 may be configured to continue determining the tee shot timestamps, the green exit timestamps, and the pace of play for each subsequent hole 310 on the golf course 300 (e.g., the second hole 314, a third hole, a fourth hole, etc.) until the last hole 316 is played by the occupants of the fourth golf cart 10d. The site monitoring and control system 200 may be configured to determine that the last hole 316 has been played by the occupants of the fourth golf cart 10d (which may be the final hole of the golf course 300 such as a 9^{th} or 18^{th} hole, or a hole prior to the final hole if the occupants do not complete a whole round) based on a certain amount of time elapsing after a last recorded green exit timestamp (e.g., ten minutes, fifteen minutes, etc.) or the fourth golf cart 10d returning to the clubhouse 304 or other designated location to store golf carts. Once it is determined that the last hole 316 has been played by the occupants of the fourth golf cart 10d, the site monitoring and control system 200 may be configured to (a) determine that the round of play is over and (b) determine the pace of play for the round based on the difference between the tee shot timestamp associated with the first hole 312 played and the green exit timestamp associated with the last hole 316 played.

The pace of play information and data may be used to monitor ongoing rounds of golf to identify groups that may be causing bottlenecks in the golf course 300 and to facilitate corrective actions (e.g., sending a staff person or Marshall out to inform the groups that they need to sped up play). The pace of play information and data may be used to understand defects in the course design and facilitate redesigning for improvements. The pace of play information and data may also be analyzed by the site monitoring and control system 200 to create player profiles for each golfer that, over time, helps generate a better understanding of how each golfer plays on the golf course 300. With such player profiles, tee sheets for each day at the golf course 300 can be dynamic based on a predicted pace of play for each of the players on the tee sheet and better optimized (e.g., player group assignments more intelligently created, etc.) such that the pace of play is more consistent, bottlenecks are avoided, more rounds of golf can be played, and the golfers have a more enjoyable experience.

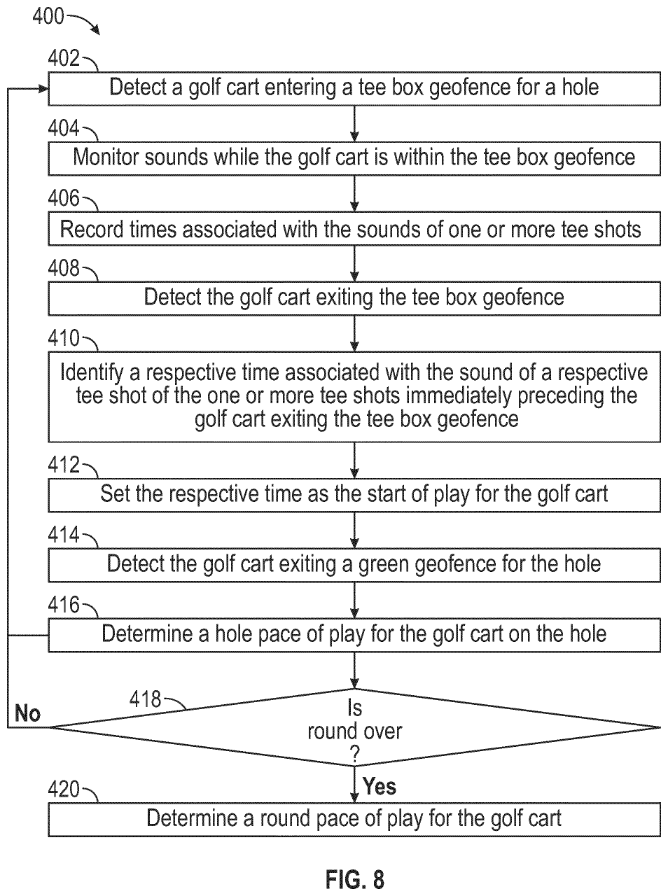

Referring now to FIG. 8, a method 400 for determining a hole pace of play and a round pace of play for a golf cart is shown, according to an exemplary embodiment. The method 400 may be performed by the site monitoring and control system 200, the vehicle controller 100, and/or the remote systems 240.

At step 402, a control system (e.g., the site monitoring and control system 200, the vehicle controller 100, the remote systems 240, etc.) is configured to detect a golf cart (e.g., the vehicle 10, the first golf cart 10a, the second golf cart 10b, the third golf cart 10c, the fourth golf cart 10d, etc.) entering a tee box geofence (e.g., the tee box geofence 328) for a hole (e.g., the first hole 312 of the round of golf). At step 404, the control system is configured to monitor sounds proximate the golf cart (e.g., by activating a microphone, using the microphone, etc. of the golf cart) while the golf cart is within the tee box geofence. At step 406, the control system is configured to record timestamps associated with the sounds of one or more tee shots.

At step 408, the control system is configured to detect the golf cart exiting the tee box geofence. At step 410, the control system is configured to identify a respective timestamp associated with the sound of a respective tee shot of the one or more tee shots immediately preceding the golf cart exiting the tee box geofence. At step 412, the control system is configured to set the respective timestamp as the start of play (for the hole and the round if the hole is the first hole played in the round) for the occupants associated with the golf cart.

At step 414, the control system is configured to detect that the golf cart is exiting a green geofence (e.g., the green geofence 346) for the hole. When the control system detects the golf cart exiting the green geofence, the control system is configured to record a green exit timestamp. At step 416, the control system is configured to determine a hole pace of play for the occupants of the golf cart on the hole based on the tee shot timestamp and the green exit timestamp for the hole.

At step 416, the control system is configured to determine whether the round of play is over (e.g., based on a certain amount of time passing since a last timestamp being recorded, if the golf cart returns to a golf cart parking area, etc.). If the control system determines that the round is still ongoing, the control system is configured to repeat steps 402-416 for each subsequent hole. If the control system determines that the round is over, the control system is configured to determine a round pace of play for the occupants of the golf cart based on the tee shot timestamp for the first hole (e.g., the first hole 312) of the round and the green exit timestamp for the last hole (e.g., the last hole 316) of the round. The hole pace of play and round pace of play data may be used to enhance or improve operations of the golf course and overall enjoyment by the players.

While tee shots have been described herein as being monitored using a microphone, it should be understood that other types of sensors may be used. By way of example, cameras or optical sensors on the vehicle 10 be used to monitor the tee box area 320 and facilitate detecting tee shots. Further, the sensors may additionally or alternatively be positioned remote from the vehicle 10 at each of the tee box areas 320 (e.g., cameras, microphones, etc. may be positioned to monitor the tee box area 320). Further, in some implementations, geofencing is not used, but rather Bluetooth beacons or other short range detection systems may be positioned at each tee box area 320 and green area 340 to detect the presence or absence of the vehicle 10 (e.g., for timestamping purposes, for microphone or other sensor activation purposes, by detecting a short range transmitter such as Bluetooth on the golf cart, etc.). Further, in some implementations, the functions of the position sensor and the microphone may be performed solely by a camera or optical sensor.

As utilized herein with respect to numerical ranges, the terms “approximately,” “about,” “substantially,” and similar terms generally mean +/−10% of the disclosed values, unless specified otherwise. As utilized herein with respect to structural features (e.g., to describe shape, size, orientation, direction, relative position, etc.), the terms “approximately,” “about,” “substantially,” and similar terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the figures. It should be noted that the orientation of various elements may differ according to other exemplary embodiments, and that such variations are intended to be encompassed by the present disclosure.

The hardware and data processing components used to implement the various processes, operations, illustrative logics, logical blocks, modules, and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems, and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the vehicle 10 and the systems and components thereof (e.g., the body 20, the operator controls 40, the driveline 50, the suspension system 60, the braking system 70, the sensors 90, the vehicle controller 100, etc.) and the site monitoring and control system 200 (e.g., the remote systems 240, the user portal 230, the user sensors 220, etc.) as shown in the various exemplary embodiments is illustrative only. Additionally, any element disclosed in one embodiment may be incorporated or utilized with any other embodiment disclosed herein.

1. A pace of play monitoring system for a golf course, the pace of play monitoring system comprising:
a first sensor configured to be positioned on a golf cart and facilitate detecting a location thereof;
a second sensor configured to facilitate detecting tee shots taken at a tee box of a hole of the golf course; and
a control system configured to:
detect that the location of the golf cart is proximate a tee box area for the tee box based on first data acquired with the first sensor;
detect one or more tee shots at the tee box based on second data acquired with the second sensor;
record one or more tee shot timestamps associated with the one or more tee shots;
detect when the golf cart leaves the tee box area based on the first data;
identify a respective tee shot timestamp of the one or more tee shot timestamps associated with a respective tee shot of the one or more tee shots immediately preceding the golf cart leaving the tee box area; and
set the respective tee shot timestamp as a start of play for one or more occupants associated with the golf cart.

2. The pace of play monitoring system of claim 1, further comprising the golf cart with the first sensor and the second sensor positioned thereon.

3. The pace of play monitoring system of claim 2, wherein the first sensor has short-range wireless communication capabilities.

4. The pace of play monitoring system of claim 2, wherein the first sensor has long-range wireless communication capabilities.

5. The pace of play monitoring system of claim 1, wherein the second sensor is configured to be positioned on the golf cart.

6. The pace of play monitoring system of claim 1, wherein the second sensor is configured to be positioned at the tee box remote from the golf cart.

7. The pace of play monitoring system of claim 1, wherein the second sensor includes at least one of a microphone, a camera, or an optical sensor.

8. The pace of play monitoring system of claim 7, wherein the second sensor includes the microphone.

9. The pace of play monitoring system of claim 1, wherein the control system is configured to be at least one of located on the golf cart or positioned remote from the golf cart.

10. The pace of play monitoring system of claim 1, wherein the control system is configured to:
detect that the location of the golf cart is proximate the tee box area for the tee box based on the first data acquired with the first sensor indicating that the golf cart is within a tee box geofence associated with the tee box area; and
activate the second sensor in response to the golf cart entering the tee box geofence.

11. The pace of play monitoring system of claim 10, wherein the control system is configured to deactivate the second sensor in response to the golf cart exiting the tee box geofence.

12. The pace of play monitoring system of claim 1, wherein the control system is configured to:
detect that the location of the golf cart is proximate a green area for a green of the hole based on the first data acquired with the first sensor;
detect when the golf cart leaves the green area and record a green exit timestamp; and
determine a pace of play for the hole based on the respective tee shot timestamp and the green exit timestamp for the hole.

13. The pace of play monitoring system of claim 1, wherein the hole is a first hole of a round of golf played by the one or more occupants, and wherein the control system is configured to:
detect that the location of the golf cart is proximate a green area for a green of another hole of the golf course based on the first data acquired with the first sensor;
detect when the golf cart leaves the green area and record a green exit timestamp;
determine that the other hole is a final hole played in the round; and
determine a pace of play for the round based on the respective tee shot timestamp for the first hole and the green exit timestamp for the final hole.

14. A pace of play monitoring system for a golf course, the pace of play monitoring system comprising:
one or more processing circuits configured to:
receive data acquired with one or more sensors, the one or more sensors configured to facilitate detecting a presence of a golf cart within a tee box area of a hole of the golf course and facilitate detecting tee shots taken at a tee box of the tee box area;
detect that the golf cart is within the tee box area based on the data;
detect one or more tee shots at the tee box based on the data;
record one or more tee shot timestamps associated with the one or more tee shots;
detect when the golf cart leaves the tee box area based on the data;
identify a respective tee shot timestamp of the one or more tee shot timestamps associated with a respective tee shot of the one or more tee shots immediately preceding the golf cart leaving the tee box area; and
set the respective tee shot timestamp as a start of play for one or more occupants associated with the golf cart.

15. The pace of play monitoring system of claim 14, further comprising the one or more sensors.

16. The pace of play monitoring system of claim 14, wherein the one or more sensors are positioned on the golf cart.

17. The pace of play monitoring system of claim 14, wherein the one or more sensors include at least one of a microphone, a position sensor, a camera, or an optical sensor.

18. The pace of play monitoring system of claim 17, wherein the one or more sensors include the microphone and the position sensor.

19. The pace of play monitoring system of claim 17, wherein the one or more processing circuits include at least one of (a) a first processing circuit configured to be positioned on the golf cart or (b) a second processing circuit configured to be positioned remote from the golf cart.

20. A pace of play monitoring system for a golf course, the pace of play monitoring system comprising:
a golf cart including a microphone and a position sensor; and
one or more processing circuits including at least one of (a) a first processing circuit positioned on the golf cart or (b) a second processing circuit positioned remote from the golf cart, the one or more processing circuits configured to:
monitor a position of the golf cart based on position data acquired with the position sensor;
activate the microphone in response to the golf cart being located within a tee box geofence associated with a tee box of the golf course;
detect one or more tee shots at the tee box based on sound data acquired with the microphone;
record one or more tee shot timestamps associated with the one or more tee shots;
deactivate the microphone in response to the golf cart being located outside of the tee box geofence;
identify a respective tee shot timestamp of the one or more tee shot timestamps associated with a respective tee shot of the one or more tee shots immediately preceding the golf cart leaving the tee box geofence; and
set the respective tee shot timestamp as a start of play of a round of golf for one or more occupants associated with the golf cart.
